(19) United States
(12) Patent Application Publication
(10) Pub. No.: US 2012/0208076 A1
(43) Pub. Date: Aug. 16, 2012

(54) ELECTROCHEMICAL CELL

(75) Inventors: Claus-Rupert Hohenthanner, Hanau (DE); Tim Schaefer, Niedersachswerfen (DE); Jens Meintschel, Bernsdorf (DE)

(73) Assignee: LI-TEC BATTERY GMBH, Kamenz (DE)

(21) Appl. No.: 13/390,546

(22) PCT Filed: Aug. 17, 2010
(86) PCT No.: PCT/EP2010/005041

§ 371 Date: Apr. 30, 2012

(30) Foreign Application Priority Data
Aug. 18, 2009 (DE) 10 2009 037 850.2

(51) Int. Cl. H01M 10/50; H01M 2/06; H01M 2/04

(52) U.S. Cl. 429/179

(57) ABSTRACT

An electrochemical cell (1) having at least one electrode stack (4), at least one conductor (3), which is connected to at least one electrode stack (4), and a casing (2, 10), which encompasses the electrode stack (4) at least partially. Wherein, at least one conductor (3) protrudes from an opening (9), partially through the cover (2, 10), and the cover (2, 10) has a first layer (5), which is made of an electrically conductive material. Additionally, in the area of the opening (9) is at least one insulating body (6, 8) arranged between said first layer (5) of the cover (2, 10) and the conductor (3).

Priority application DE 10 2009 037 850.2 as filed on August 18, 2009 is hereby incorporated by reference and therefore part of the present description.

The invention relates to an electrochemical cell, in particular a flat battery cell. Such cells are used, for example, in electric vehicles.

Generally, storage elements for electrical energy in form of electrochemical elements are known in the art. Therein, electrical energy is stored in these electrochemical elements, which, for example, are enclosed by means of a foil-like packaging. Conductors provide electrical connections to this electrical cell and thereby partially protrude through the cover. In particular, due to improved thermal conductivity, the cover of such electrochemical cells is made out of a material that exhibits good thermal conductivity.

DE 600 29 123 T2 shows an electrochemical cell. Therein, an electrical cell is provided in the form of a roll pack that is incorporated inside a metal box. A positive and a negative conductor are provided, which are connected to the electrodes of the roll pack. A ring-shaped plastic element is provided, which electrically insulates the positive terminal of the metal box.

The object of the present invention is to provide an improved electrochemical cell.

This object is achieved by an electrochemical cell with at least one electrode stack, at least one conductor, which is connected to at least one electrode stack, and a cover, which at least partially surrounds the electrode stack. At least one conductor protrudes from an opening and partially extends through the cover. Said cover has a first layer, which is made of an electrically conductive material. Moreover, at least in the area of the opening, an insulating body is arranged between the first layer and the conductor. The electrochemical cell according to the present invention may be configured, in particular, as a flat battery cell.

In accordance with the present invention, the term “electrode stack” refers to an arrangement, which serves for the storage of chemical energy and for the release of electrical energy. For this purpose, the electrode stack has several plate-shaped elements, at least two electrodes, namely, one anode and one cathode, and a separator, which at least partially takes up an electrolyte. Preferably, at least one anode, one separator, and one cathode are placed or stacked above one another, wherein the separator is at least partially arranged between the anode and the cathode. This sequence of anode, separator, and cathode may be repeated within the electrode stack as often as desired. Preferably, the plate-shaped elements are wound into an electrode coil. In the following, the term “electrode stack” is also used for electrode coils (“Elektrodenwickel”). Prior to the discharge of electrical energy, the chemical energy as stored is converted into electrical energy. During the charging process, the electrical energy as supplied to the electrode stack is converted into chemical energy and stored. Preferably, the electrode stack has multiple pairs of electrodes and separators. Particularly preferably, some electrodes are connected with each other, in particular, electrically connected with each other.

According to the present invention, a “conductor” refers to a device, which (also) allows for the flow of electrons from an electrode in the direction of an electrical load. The conductor may also act in the opposite direction of the current flow. A conductor may be electrically connected to an electrode or, respectively, to an active electrode-mass of the electrode stack and further, may be connected to a cable. The shape of the conductor is, preferably, adapted to the shape of the electrode stack. Preferably, a conductor is provided in a plate-like or foil-like manner. Preferably, each electrode of the electrode stack has a separate conductor or, respectively, electrodes of the same polarity are connected to a common conductor.

According to the present invention, a “cover” refers to at least a partial boundary, which separates the electrode stack from the outside environment. The cover is preferably gas- and liquid-tight, so that no material exchange with the environment may take place. The electrode stack is arranged within the cover. At least one conductor, in particular two conductors, protrude through the cover and is/are used to connect the electrode stack. The outwardly protruding conductors, provide, preferably, the connection for the plus pole and for the minus pole of the electrochemical cell. However, it is also conceivable that several conductors protrude through the cover, in particular, two or four conductors.

According to the present invention, an “insulating body” is, in particular, an arrangement, which may prevent an electrically-conducting connection between two components, or at least hinder the same, such that only a negligible electric current flows between these components. The insulating body is, in particular, provided to be at least in indirect contact, in particular, in direct contact with both components. Therefore, the insulating body is, preferably, made of a material with low electrical conductivity. The insulating body has, preferably, some degree of mechanical stability, in particular, stability against pressure load in order to be able to transmit mechanical forces or momentum from one component to another component.

Due to the fact that the insulating body is arranged between the conductor and the first layer of the cover which comprises an electrically conductive material, the danger of voltage breakdowns or, respectively, of unwanted leakage currents from the conductor to the cover, may be reduced. Said danger occurs, in particular, in the case of flat battery cells, and, in particular, when the opening through which the conductor protrudes through the cover is, at the same time, part of a seam between parts of the cover. The seams are, preferably, sealed, by processes involving an exposure to pressure, which further reduces the distance between the conductor and the current conducting part of the cover.

The danger of electrical voltage breakdowns or, respectively, of unwanted leakage currents from the conductor to the cover, may be further reduced by at least one of the following options, which may be applied individually or in combination with each other.

The insulating body is, preferably, a flat body. i.e. the insulating body has, as opposed to its width and to its length, a very small thickness. The insulating body has preferably, a first portion, which is in contact with the conductor and a second portion, which is spaced apart from the conductor. Since the first layer of the cover is arranged on a side of the insulating body that faces away from the conductor, the first layer is exposed to forces in the area of the second portion of the insulating body, away from the current conductor. Hence, there is a greater distance between the first layer of the cover and the conductor, which is favorable for improved insulation. Therein, the first portion is, preferably, arranged at an angle to the second portion of the insulating body. In particular, an angle between the first portion and the second portion of the insulating body is more than 90°, in particular, about 180°. At an angle of about 180° or slightly less, a folding of the insulating body in a seam-like manner may result.

Preferably, the first layer of the cover is at least partially arranged between the first portion and the second portion of the insulating body. In particular, in case there is an angle of more than 90° between the first portion and the second portion of the insulating body, a receiving space is thereby formed between said two portions of the insulating bodies, in which the first layer of the cover may be included, at least partially, and is thereby well isolated vis-à-vis the conductor. In particular, at an angle of 180° between the two portions of the insulating body, which may result in an folded arrangement of the portions in a seam-like manner, the first layer of the cover may also be held, in particular, in a folding-pattern, in a seam-like manner between the first portion and the second portion of the insulating body, which favors good insulation.

Preferably, the first layer of the cover has a first portion, which is in contact with the insulating body, in particular, with the first portion of the insulating body. Furthermore, the first layer of the cover also has a second portion, which is arranged at an angle, in particular relative to the first portion of the first layer. The second portion is arranged to be directed away from the direction of the conductor, in particular at an angle thereto. By means of the arrangement of the second portion, which is preferably but not necessarily in contact with the insulating body, a distance between the second layer of the cover and the conductor will be enlarged, whereby an improved insulation is favored.

Preferably, the first portion of the first layer of the cover is in contact with the first portion of the insulating body, and the second portion of the first layer of the cover is in contact with the second portion of the insulating body. Here, in particular, the orientation of the first and of the second portions of the insulating body, may be implemented to be in accordance with the above described embodiments. In particular, if an angle between the first portion and the second portion of the insulating body is equal to or greater than 90°, in particular, about 180°, and the first layer of the cover is arranged on the side of the insulating body, which faces away from the conductor, the first layer will be held towards the conductor at a spacing, which favors an improved insulation.

In a second preferred embodiment, an arrangement may be provided, in which the insulating body extends beyond the first layer in the area of an opening. This means, in particular, that a first portion of the insulating body is in contact with a first layer of the cover, while a second portion of the insulating body, which is arranged in a manner to face away from the electrode stack, is not in contact with the first layer of the cover. The term “extending beyond” means, in particular, that the insulating body extends along the conductor in the direction from the battery interior to the battery exterior and that it extends farther in the direction of the battery exterior than the first layer of the cover. An arrangement may be provided, in which in the area of an opening, the insulating body is generally designed to be longer than in another area of the cover. Alternatively, or in combination with this, an arrangement may be provided in which, in the area of an opening, the first layer is designed to be shorter, compared to other areas of the cover. The terms “longer” or “shorter” refer, according to the present invention, to the extension of the cover or of the insulating body in the direction from the battery interior to the battery exterior, i.e. in the breakthrough-direction of the opening.

In all of the above-mentioned preferred embodiments, whose specific embodiment or further developments may generally be applied on an individual basis or in combination with the specific embodiment or the further developments of another preferred embodiment as disclosed, in general, a current path, which may be formed between the first layer of the cover and the conductor, will be made longer. This leads to the reduction of the occurrence of voltage breakdowns as well as of unwanted leakage currents, in particular since the electrical resistance of the current path is increased.

Preferably, the insulating body is part of the cover. An arrangement may be provided in which the cover is made in the form of a multilayer and which comprises a second layer, in particular, of an insulating material, which is disposed within the first layer. The second layer of insulating material may actually provide the insulating body. The second layer of the insulating material may, preferably, be a plastic layer. The term “within the first layer” refers, in particular, to the fact, that the second layer is arranged between the electric cell and the first layer and/or between the conductor and the first layer. The term “within the first layer” refers, in particular, to the fact, that, starting from the first layer, the second layer faces an inner space of the electrochemical cell.

The cover may, at least partially, be made of a film, in particular, of a packaging film. The first layer of the packaging film may be made of aluminum and, in particular, of an aluminum foil.

Alternatively to, or in combination with this, in a third embodiment, the cover may be made, at least partially, of a heat conducting plate. The heat conducting plate is, preferably, at least partially made of an electrically conductive material, which may result in an improved thermal conductivity. The heat conducting plate may also be bent, folded, or shortened towards to the insulating body, as in accordance with any of the aforementioned embodiments. The cover, which is partially made of a heat conducting plate, may be made, in accordance with the aforementioned embodiments, of several layers.

Alternatively to, or in combination with this, a separate sealant may be arranged between the cover and the conductor. The sealant preferably seals an annular space (“Ringraum”), which is present between the cover and a conductor in the area of the opening. The sealant may be the insulating body. Additionally, or alternatively to the aforementioned insulating second layer of the cover, the sealant may contribute to an improved insulation. The same aforementioned possibilities and embodiments, which were already explained with respect to the design of the insulating body, apply, mutatis mutandis, to the sealant.

The insulating body and/or the first layer of the cover may, preferably, be fixed in regard to their position in the sealing area. This ensures, in particular for insulating bodies or, respectively, for first layers, made of flexible material, that the extended current path, which is achieved by the aforementioned measures, is also maintained during extensive use. In particular, when the first layer is bent and/or folded, this condition will be permanently maintained due to these fixing means. Preferably, the first layer may be fixed in its bent and/or folded position, by means of fixing by material engagement. The term “fixing by material engagement” refers, preferably, to an engagement by glueing or by welding.

Alternatively to, or in combination with, the aforementioned fixing means, a fixing element may be provided, which fixes the insulating body and/or the first layer of the cover in its bent position. A fixing element may preferably be provided in the form of a clamp or a strap.

Below, the invention is further explained in detail with reference to the figures, which show:

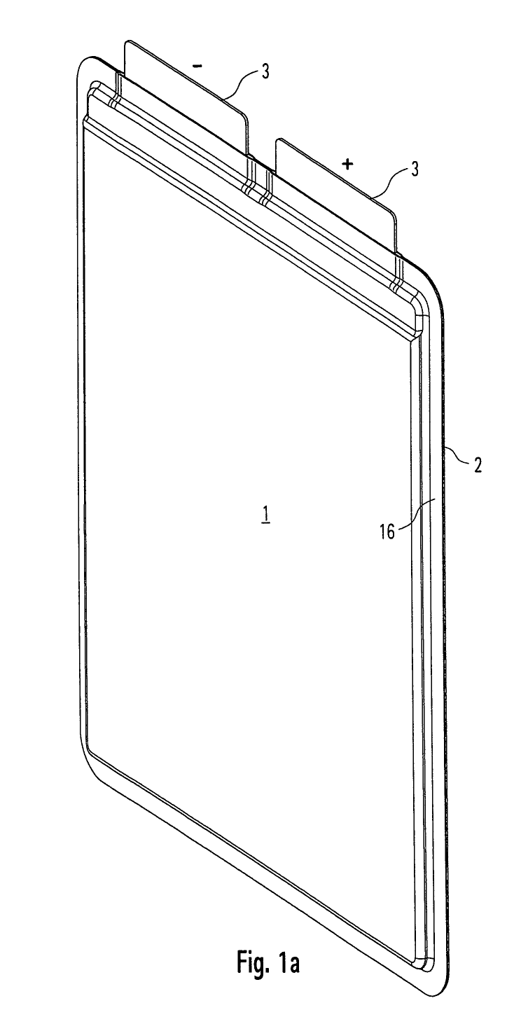

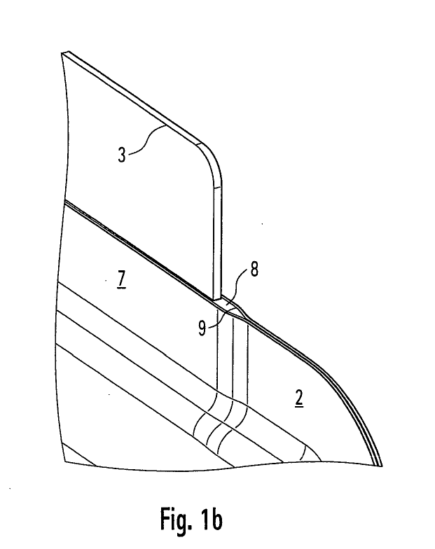

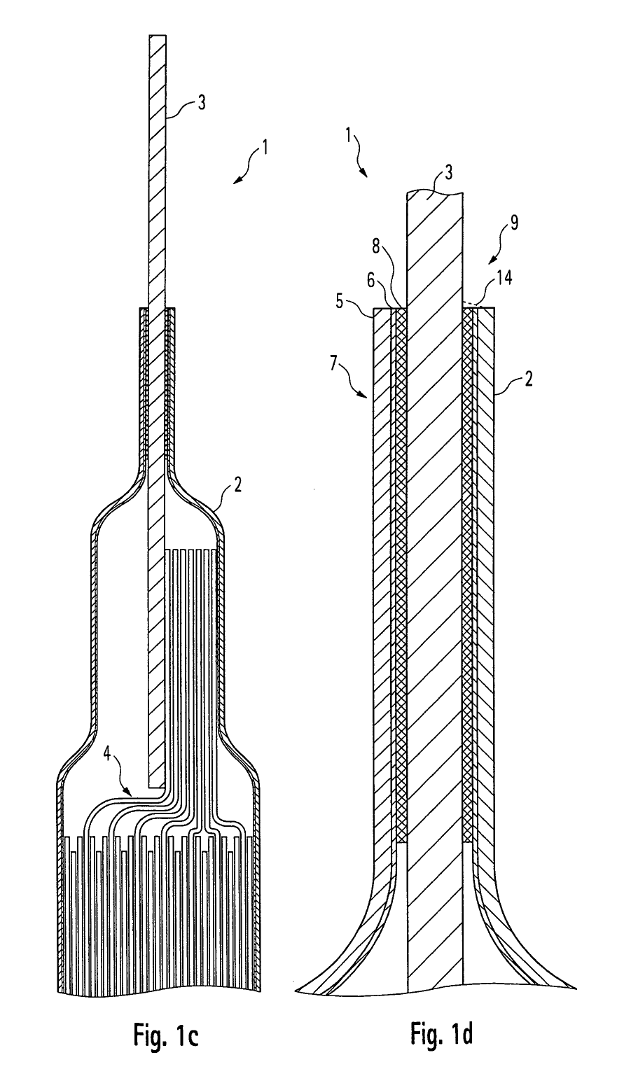

FIG. 1 shows an electrochemical cell according to the invention in a basic version
a) in perspective view;
b) in a perspective view with a magnified sealing area,
c) in a cross-section of an area of the conductor,
d) in a magnified cross-section in the sealing area;

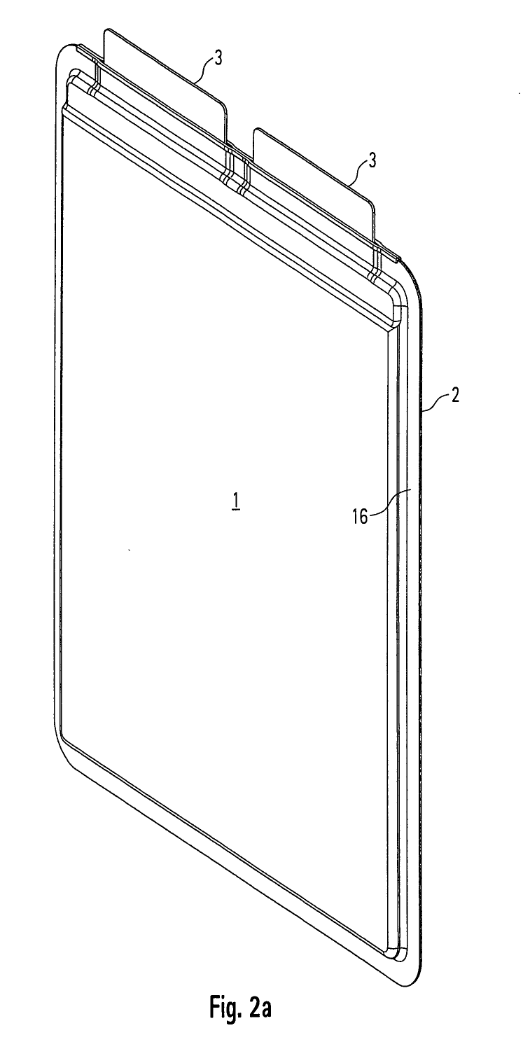

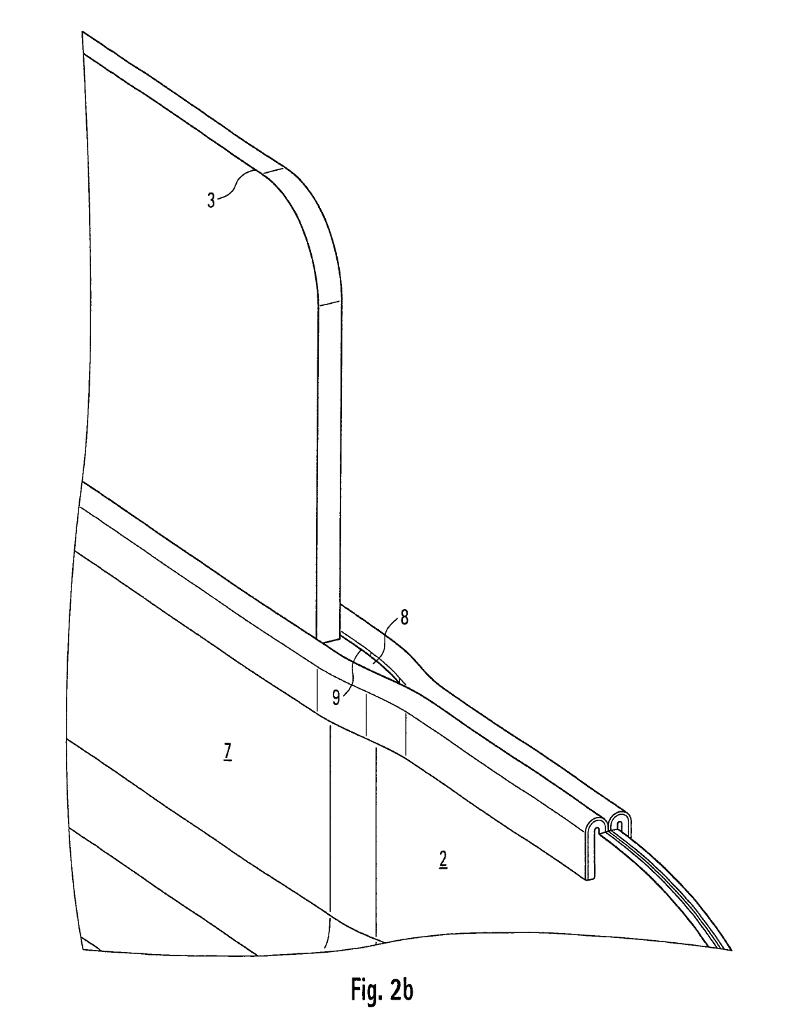

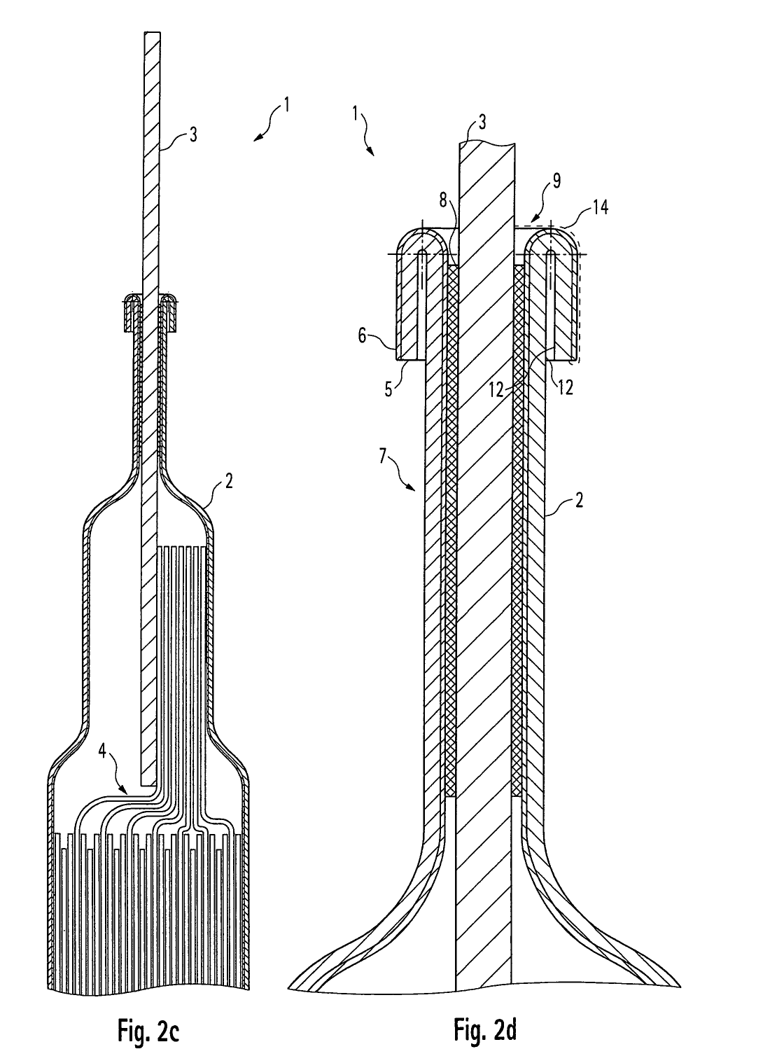

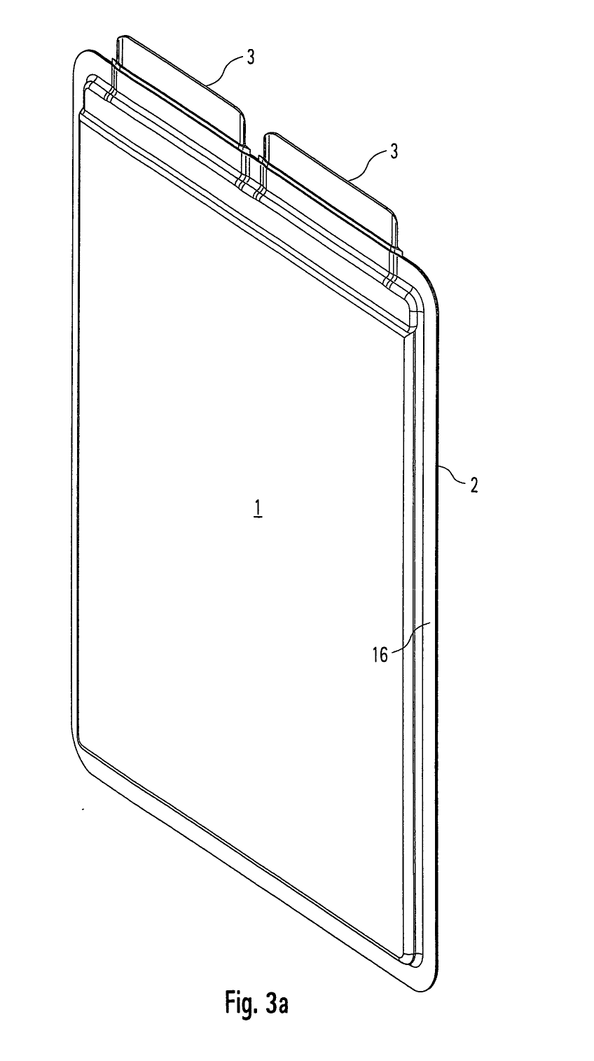

FIG. 2 shows an electrochemical cell according to the invention in a first embodiment
a) in perspective view;
b) in a perspective view with a magnified sealing area,
c) in a cross-section of an area of the conductor,
d) in a magnified cross-section in the sealing area;

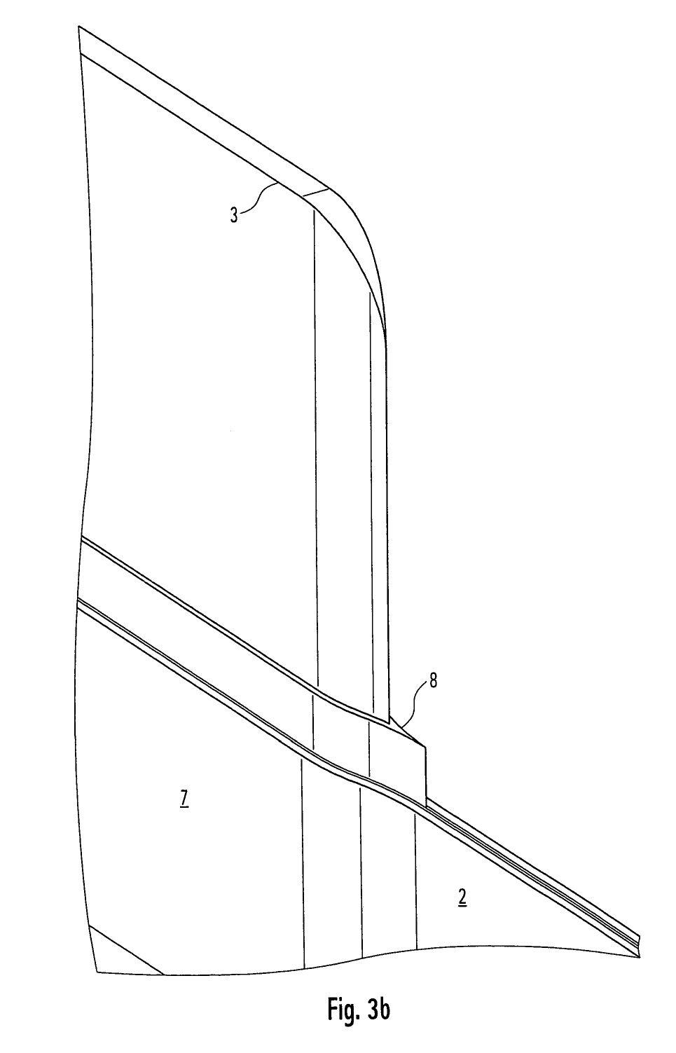

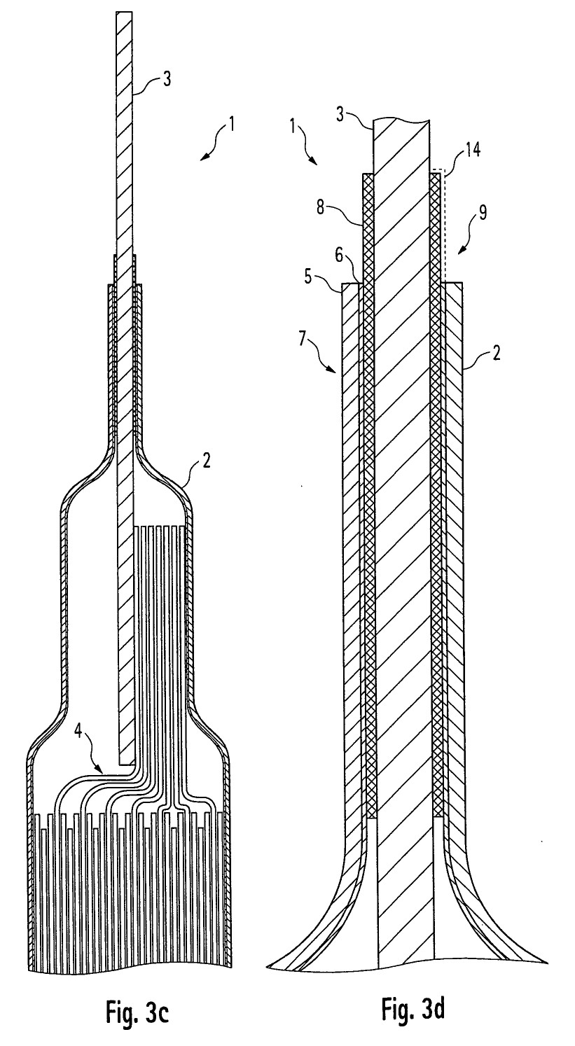

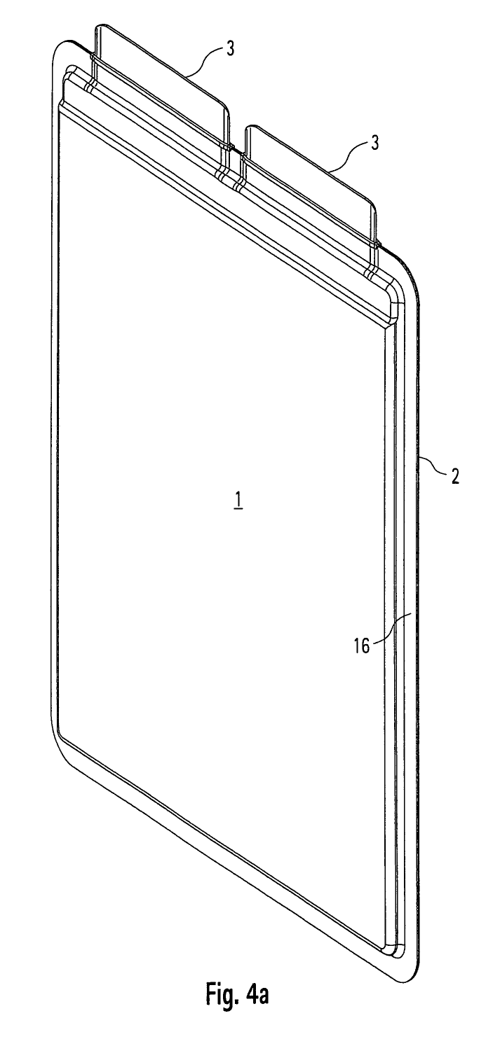

FIG. 3 shows an electrochemical cell according to the invention in a second embodiment
a) in perspective view;
b) in a perspective view with a magnified sealing area,
c) in a cross-section of an area of the conductor,
d) in a magnified cross-section in the sealing area;

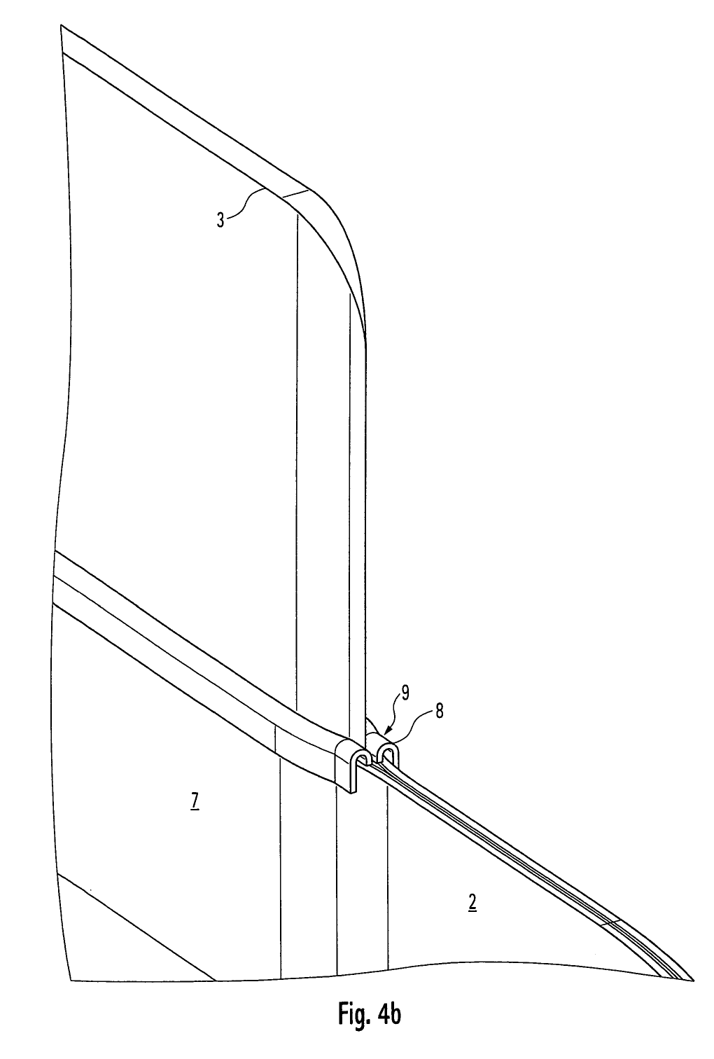

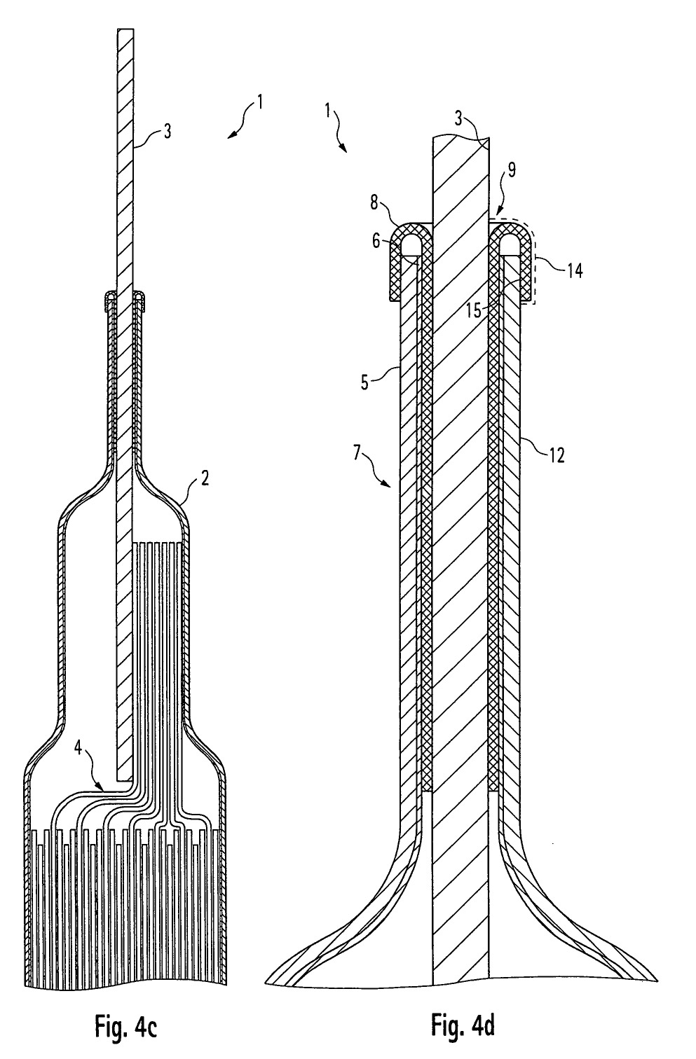

FIG. 4 shows an electrochemical cell according to the invention in a further development of the second embodiment,
a) in perspective view;
b) in a perspective view with a magnified sealing area,
c) in a cross-section of an area of the conductor,
d) in a magnified cross-section in the sealing area; and

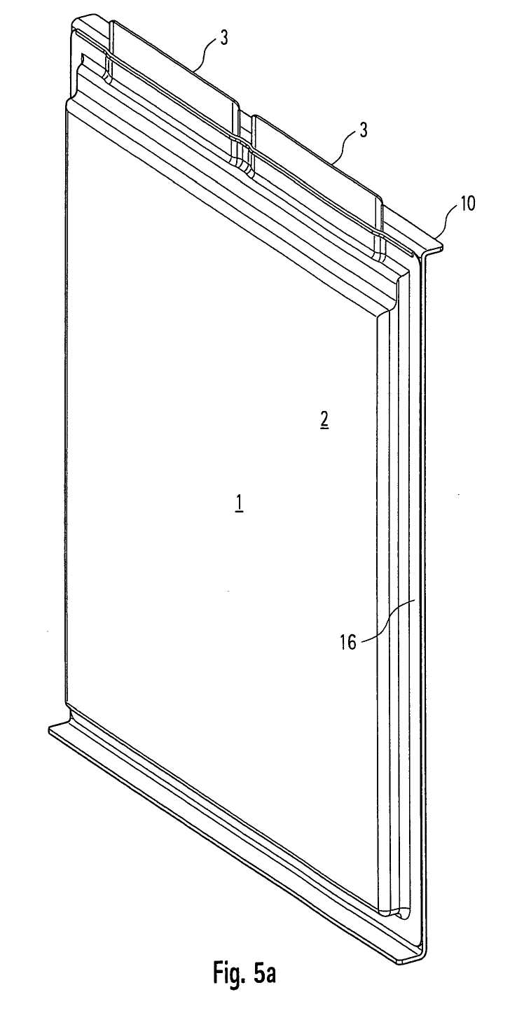

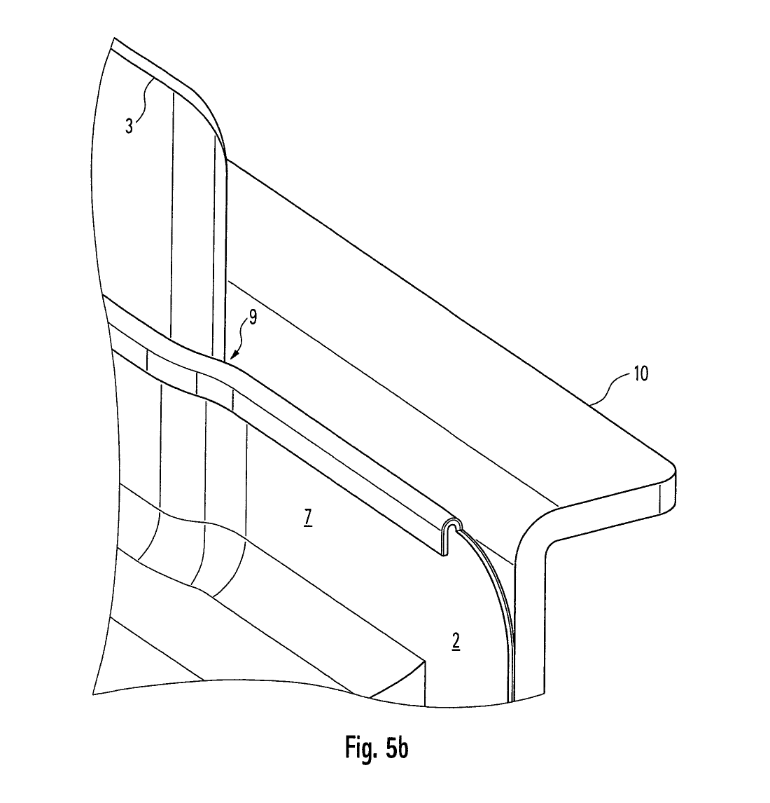

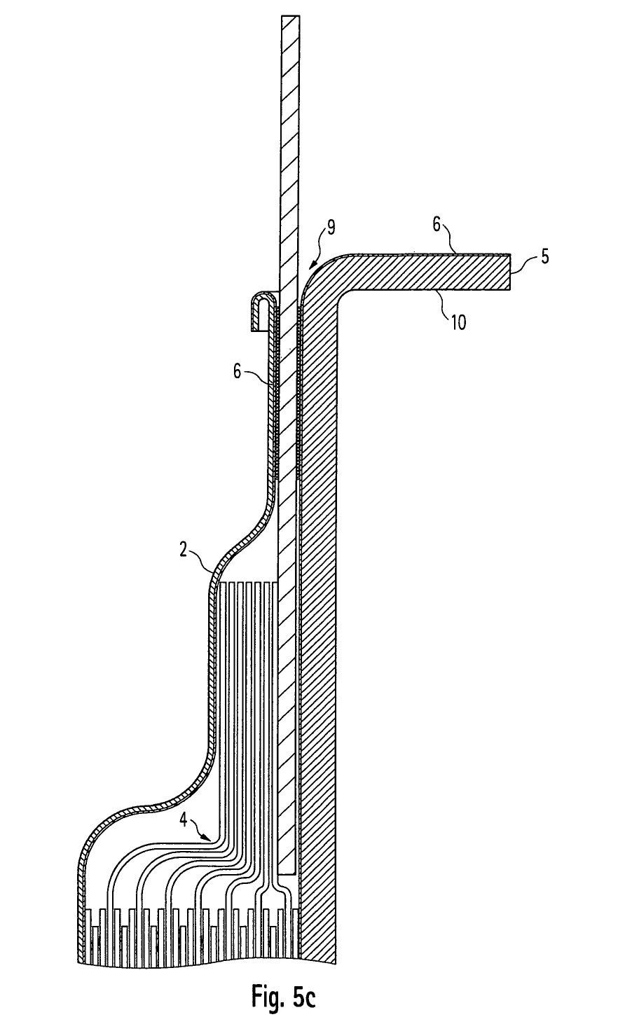

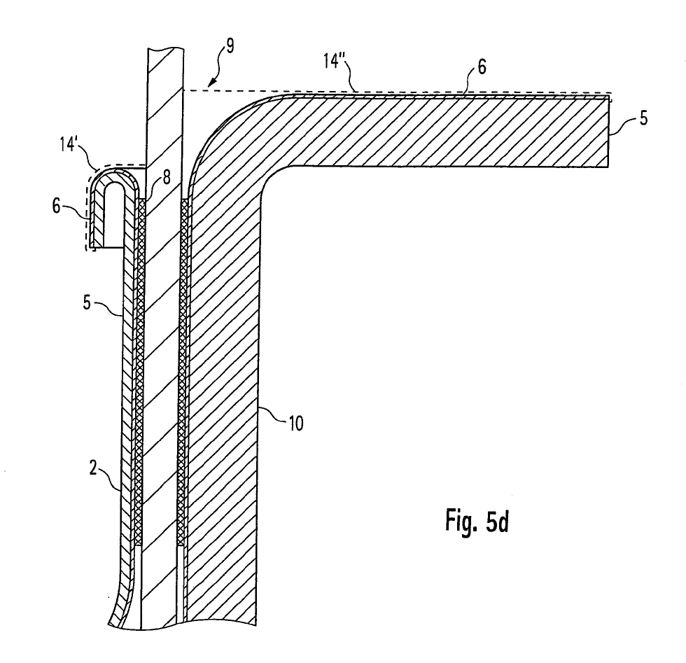

FIG. 5 shows an electrochemical cell according to the invention in a third embodiment
a) in perspective view;
b) in a perspective view with a magnified sealing area,
c) in a cross-section of an area of the conductor,
d) in a magnified cross-section in the sealing area;

FIG. 1 shows an electrochemical cell 1 according to the invention, in a flat form and in a basic version. The electrochemical cell 1 has a cover 2, which is made of a packaging film. Further, two conductors 3 are provided, which protrude from an opening 9 through the cover 2 of the electrochemical cell 1. Within the cover 2, the conductors 3 are electrically connected to an electrode stack 4 of the electrochemical cell, and thus provide electrical connections of the electrochemical cell. Conductors 3 are made of sheet metal. Conductors 3 have a flat shape. A breakthrough direction, which is coaxial to the opening 9, is arranged in parallel to a planar orientation of the conductor.

As shown, in particular, in FIG. 1d), the cover 2 is made of a packaging film, which has a multilayer structure. Here, an aluminum layer 5 is provided, which forms the outer layer of the packaging film 2. Furthermore, a plastic layer 6 is provided on the inside of the aluminum layer 5, which provides an insulation between the conductor 3 and the aluminum layer 5. The packaging film 2 constitutes both halves of the entire cover, wherein each half is realized as a cover shell. By putting together two cover shells, the entire cover is formed. The assembly of the cover is carried out by means of pressure application to the seam portions 16 of the film 2.

Furthermore, a sealant 8 is provided in the sealing area 7, which is the area from which the conductor 3 protrudes from an opening 9 through the cover 2, and which is, at the same time, part of the seam of the cover in the area of the opening 9; furthermore, said sealant 8 is arranged between the packaging film 2 and the conductor 3. The sealant 8 seals an annular space between the cover 2 and a conductor 3 in the area of the opening 9. The sealant 8 is made of a tape of insulating material and wrapped around the conductor. A leakage current would run along a current path 14, which is indicated by a dashed line between the conductor 3 and the aluminum layer 5.

FIG. 2 shows an electrochemical cell 1 in a first embodiment, which represents a further development of the electrochemical cell 1 according to the basic version. In the following, only the differences to the electrochemical cell according to FIG. 1, are discussed.

It is apparent that, in the area of the opening 9, film 2 is bent towards the outside, i.e. bent away from the conductor 3. It is apparent, that the plastic layer 6, which represents an insulating body, has a first portion 17, which is arranged in indirect contact with the conductor 3. Between the first portion 17 of the plastic layer 6 and the conductor 3, furthermore sealant 8 is provided. Furthermore, the plastic layer 6 has a second portion 18, which is arranged at an angle of 180° relative to the first portion 17 of the plastic layer. Furthermore, the aluminum layer 5 of the film 2 has a first portion 19, which is in contact with the first portion 17 of the plastic layer 6. Furthermore, the aluminum layer 5 has a second portion 20 which is in contact with the second portion 18 of the plastic layer 6. The first portion 19 and the second portion 20 of the aluminum layer 5 are also arranged at an angle of 180° relative to each other. Here, the aluminum layer 5 with its first and its second portions 19, 20 is enclosed by the plastic layer in a seam-like manner. Two outer surface areas 12 of the film 2, more precisely, two outer surface areas 12 of the aluminum layer 5 of the film 2, which each are arranged before or, respectively, after the area of bending 13 of the film 2, are in contact with each other.

Between the two outer surface areas 12, a glueing means (not shown) is arranged, which joins together the outer surface areas by material engagement, and thereby fixes film 2 in the position shown. Current path 14, indicated by a dashed line, has to be overcome by the current, to reach aluminum layer 5, starting from the conductor 3, and by means of bypassing the insulating plastic layer 6. It is apparent that the current path 14 is significantly longer than in the battery assembly according to FIG. 1. In this respect, the electrochemical cell according to FIG. 2, provides more precaution against voltage breakdowns, as well as against leakage currents.

FIG. 3 shows an electrochemical cell 1 in a second embodiment, which represents a further development of the electrochemical cell in accordance with the basic version. In the following, only the differences to the electrochemical cell according to FIG. 1 will be discussed.

It is apparent that sealant 8, which represents an insulating body, extends beyond film 2 along a breakthrough-direction, which runs in parallel to the direction of the conductor 3, i.e. the sealant 8 protrudes further from the opening 9 than the aluminum layer 5. A first portion 17 of the sealant 8 is in indirect contact with a first portion 19 of the aluminum layer 5, wherein the plastic layer 6 is arranged between the aluminum layer 5 and the sealant 8. A second portion 18 of the sealant 8 is not in contact with film 2 not with a portion of the aluminum layer 5.

Also for this embodiment, the current path 14 is illustrated by dashed lines. It can be seen that the current path 14 is significantly longer than in the electrochemical cell according to FIG. 1. Insofar, the electrochemical cell 1 according to FIG. 3, provides better safety guards against voltage-breakdowns, as well as against leakage currents. The sealant 8 according to the electrochemical cell of FIG. 3 may also be implemented in an electrochemical cell according to the FIG. 2.

FIG. 4 shows a further development of the electrochemical cell of the second embodiment according to FIG. 3. In the following, only the differences to the electrochemical cell according to FIG. 3 will be discussed.

In addition to the embodiment according to FIG. 3 in the area of the opening, the sealant 8 is folded by 180° in a seam-like manner and thereby encompasses film 2 in a U-shape. A first portion 17 of the sealant 8 is indirectly in contact with a first portion 19 of aluminum layer 5. Plastic layer 6 is arranged between aluminum layer 5 and sealant 8. A second portion 18 of sealant 8 is arranged at an angle of 180°, relative to the first portion 17 of sealant 8. A border area is incorporated, namely the first portion 19 of the aluminum layer 5, between the first portion 17 and the second portion 18 of the sealant 8. The outer surface area 15 of the sealant 8 is in contact with an outer surface area 12 of aluminum layer 5. Outer surface area 15 of sealant is connected with outer surface area 12 of the aluminum layer by material engagement using a welding process.

It is apparent that the current path 14 is significantly longer compared to the arrangement according to FIG. 1. Insofar, the electrochemical cell 1, according to FIG. 4, provides better safety guards against voltage breakdowns, as well as against current leakages. Sealant 8 according to the electrochemical cell of FIG. 4 may also readily be incorporated into an electrochemical cell according to FIG. 2. Insofar, the sealants according to FIG. 4 may also encompass the folded film 2 according to FIG. 2.

FIG. 5 shows a further development of the electrochemical cell according to FIG. 2 in a third embodiment. In the following, only the differences to the electrochemical cell according to FIG. 2 will be discussed.

Cover 2 is made, on one side of the electrochemical cell 1, of a film 2 according to the electrochemical cells of the previous figures. On the other side of the electrochemical cell 1, the cover comprises a heat conducting plate 10. The assembly of heat conducting plate and film 2 is implemented under pressure application on the seam portions 16 of the film 2 or, respectively, the heat conducting plate 10. The heat conducting plate 10 has a multilayer structure and has, analogous to film 2, an aluminum layer 5 and a plastic layer 6, wherein the plastic layer 6 is arranged within the aluminum layer 5. The heat conducting plate 10 is bent at a right angle towards the outside in the area of the opening 9. A first portion 17 of the plastic layer 6 is indirectly in contact with the conductor 3, wherein sealant 8 is arranged between plastic layer 6 and conductor 3. The plastic layer 6 has a second portion 18, which is arranged at a right angle towards the first portion 17 of the plastic layer 6, and extends away, perpendicular to conductor 3. Aluminum layer 5 has a first portion 19, which is in contact with a first portion 17 of the plastic layer. Furthermore, a second portion 20 of aluminum layer 5 is arranged at a right angle relative to the first portion 19 of the aluminum layer 5. The first or, respectively, the second portions are arranged in parallel to each other.

On the other side of the electrochemical cell 1, the side at which cover 2 is illustrated by means of film 2, said film 2 is in the area of the opening 9, analoguous to the electrochemical cell according to FIG. 2. On each of the sides of the electrochemical cell 1, current paths 14′, 14″ are illustrated with dashed lines. It is apparent that both current paths 14 are significantly longer than in the arrangement according to FIG. 1. Insofar, the electrochemical cell 1 according to FIG. 5, provides bettery safety measures against voltage breakdown as well as against current leakage.

### LIST OF REFERENCE NUMERALS

1. Electrochemical cell
2. Film
3. Conductor
4. Electrode stack
5. Aluminum layer
6. Plastic layer
7. Sealing area
8. Sealant
9. Opening
10. Cover
12. Outer surface area
13. Area of bending
14. Current path
15. Outer surface area
16. Seam portion
17. First portion of the insulating body
18. Second portion of the insulating body
19. First portion of the first layer
20. Second portion of the first layer

1-15. (canceled)

16. Electrochemical cell (1), comprising
at least one electrode stack (4),
at least one conductor (3), which is connected to at least one electrode stack (4), and a cover (2, 10), which at least partially encloses electrode stack (4),
wherein at least one conductor (3) partially protrudes from an opening (9) through the cover (2, 10),
wherein the cover (2, 10), has a first layer (5), which is made of an electrically conductive material,
wherein, at least in the area of the opening (9), an insulating body (6, 8) is arranged between the first layer (5) of the cover (2, 10) and the conductor (3)
wherein
a separate, electrically insulating sealant (8) is arranged between the cover (2, 10) and the conductor (3).

17. The electrochemical cell according to claim 16,
wherein
the sealant seals an annular space, which exists between the cover and a conductor in the area of the opening.

18. The electrochemical cell according to claim 17,
wherein
the sealant (8) is made of a band of insulating material and is wrapped around the conductor.

19. The electrochemical cell according to claim 18,
wherein
the sealant (8) protrudes farther from the opening (9) than the first electrically conductive layer (5).

20. The electrochemical cell according to claim 19,
wherein
the sealant (8) is folded, in the area of the opening (9) in a seam-like manner by 180° and thereby encompasses the cover (2) in a U-shape.

21. The electrochemical cell according to claim 20,
wherein
a first portion (17) of the sealant (8) is in indirect contact with a first portion (19) of the aluminum layer (5).

22. The electrochemical cell according to claim 21,
wherein
a plastic layer (6) is arranged between the first electrically conductive layer (5) and the sealant (8),

23. The electrochemical cell according to claim 22,
wherein
a second portion (18) of the sealant (8) is arranged at an angle of 180° relative to the first portion (17) of the sealant (8)

24. The electrochemical cell according to claim 23,
wherein
a border area, namely the first portion (19) of the first electrically conductive layer (5), is incorporated between the first portion (17) and the second portion (18) of the sealant (8),
wherein an outer surface (15) of the sealant is in contact with an outer surface (12) of the first layer (5).

25. The electrochemical cell according to claim 24,
wherein
the outer surface (15) of the sealant is connected with the outer surface (12) of the first layer (5) by means of material engagement and by a welding process.

26. The electrochemical cell according to claim 16,
wherein
the insulating body (6, 8) has a first portion (17), which is in contact with the conductor (3), and has a second portion (18), which is spaced apart from the conductor (3).

27. The electrochemical cell according to claim 26,
wherein
the first portion (17) of the insulating body (6, 8) is arranged at an angle relative to the second portion (18) of the insulating body (6, 8).

28. The electrochemical cell according to claim 27
wherein
the first layer (5) of the cover (2, 10) is at least partially arranged between the first portion (17) and the second portion (18) of the insulating body.

29. The electrochemical cell according to claim 28,
wherein
the first layer (5) of the cover (2, 10) has a first portion (19), which is in contact with the insulating body (6, 8), in particular with the first portion (17) of the insulating body (6, 8), and that
the first layer (5) of the cover (2, 10) has a second portion (20), wherein the first portion (19) of the first layer (5) is arranged at an angle relative to the second portion (20) of the first layer (5).

30. The electrochemical cell according to claim 29,
wherein
the first portion (19) of the first layer (5) of the cover (2, 10) is in contact with the first portion (17) of the insulating body (2, 10) and the second portion (20) of the first layer (5) of the cover (2, 10) is in contact with the second portion (20) of the insulating body (2, 10).

31. The electrochemical cell according to claim 30,
wherein
the insulating body (6, 8) protrudes beyond the first layer (5) in the area of the opening (9).

32. The electrochemical cell according to claim 31,
wherein
the insulating body (6) is part of the cover (2, 10).

33. The electrochemical cell according to claim 32,
wherein
the cover (2, 10) is made of several layers and that a second layer (6) is made, in particular, of an insulating material, in particular, which comprises a plastic layer, which is arranged within the first layer (5), wherein the second layer forms the insulating body.

34. The electrochemical cell according to claim 33,
wherein
the cover (2, 10), is at least partially made of a film (2), in particular of a packaging film.

35. The electrochemical cell according to claim 34,
wherein
the cover (2, 10), is at least partially formed by a thermally conductive plate (10).

36. The electrochemical cell according to claim 35,
wherein
a separate sealant (8), which forms the insulating body, is arranged between the cover (2, 10) and the conductor (3).

37. The electrochemical cell according to claim 36,
wherein
the insulating body (6, 8) and/or the first layer (5) of the cover (2, 10) is/are fixed in respect to their position in the area of the opening (9).

38. The electrochemical cell according to claim 37,
wherein
the first layer (5) of the cover (2, 10) and/or the insulating body (6, 8) is/are fixed in a bent position, in particular, by means of a fixing by material engagement or by means of a fixing element.

39. An electrochemical energy storage device comprising at least one electrochemical cell according to claim 1.
